(19) United States
(12) Patent Application Publication
(10) Pub. No.: US 2014/0177207 A1
(43) Pub. Date: Jun. 26, 2014

(54) BACKLIGHT MODULE

(71) Applicant: HON HAI PRECISION INDUSTRY CO., LTD., New Taipei (TW)

(72) Inventor: I-THUN LIN, New Taipei (TW)

(73) Assignee: HON HAI PRECISION INDUSTRY CO., LTD., New Taipei (TW)

(21) Appl. No.: 14/018,431

(22) Filed: Sep. 5, 2013

(30) Foreign Application Priority Data
Dec. 26, 2012 (TW) 101150271

(51) Int. Cl. G02F 1/1335; G02B 5/02

(52) U.S. Cl. CPC G02F 1/133606; G02B 5/0278
USPC 362/97.1

(57) ABSTRACT

An exemplary backlight module includes a substrate, a lighting chip mounted on the substrate and a light diffusion board located above the lighting chip. The light diffusion board includes a main body and a diffusion-enhancing portion arranged in the main body. The diffusion-enhancing portion has higher light diffusibility than that of other portion in the main body. The lighting chip is aligned with the diffusion-enhancing portion. The diffusion-enhancing portion has a light diffusibility which is gradually decreased from a center of the diffusion-enhancing portion toward a periphery of the diffusion-enhancing portion.

### BACKGROUND

1. Technical Field

The disclosure generally relates to lighting sources, and particularly, to a backlight module having a light diffusion board with a plurality of diffusion-enhancing portions for generating an evenly-distributed plane light to illuminate an LCD (liquid crystal display).

2. Description of Related Art

A conventional backlight module includes a substrate, a plurality of light emitting diode (LED) packages arranged on the substrate, and a light diffusion board spaced from and located over the LED packages.

However, each LED package generates a smooth round light field, and the light emitted from the LED package is mainly concentrated at a center thereof. The light at a periphery of the LED package is relatively poor to illuminate. Therefore, the light emitted from the LED packages can not be uniformly emitted out from the light diffusion board. When this happens, the performance of the backlight module will be unfavorably affected.

What is needed, therefore, is a backlight module which can overcome the described-above shortcomings.

### BRIEF DESCRIPTION OF THE DRAWINGS

FIG. 1 is a schematic, assembled view of a backlight module in accordance with a first embodiment of the present disclosure.

FIG. 2 is a cross-sectional view of the backlight module of FIG. 1, taken along line II-II thereof.

FIG. 3 shows light paths of a lighting chip of the backlight module of FIG. 1.

FIG. 4 is a schematic, assembled view of another backlight module in cross section in accordance with a second embodiment of the present disclosure.

FIG. 5 is a perspective view of a lens of FIG. 4.

FIG. 6 is an inverted view of the lens of FIG. 5.

FIG. 7 shows light paths of a lighting chip of the backlight module of FIG. 4.

### DETAILED DESCRIPTION

Exemplary embodiments of backlight modules in accordance with the present disclosure will now be described in detail below and with reference to the drawings.

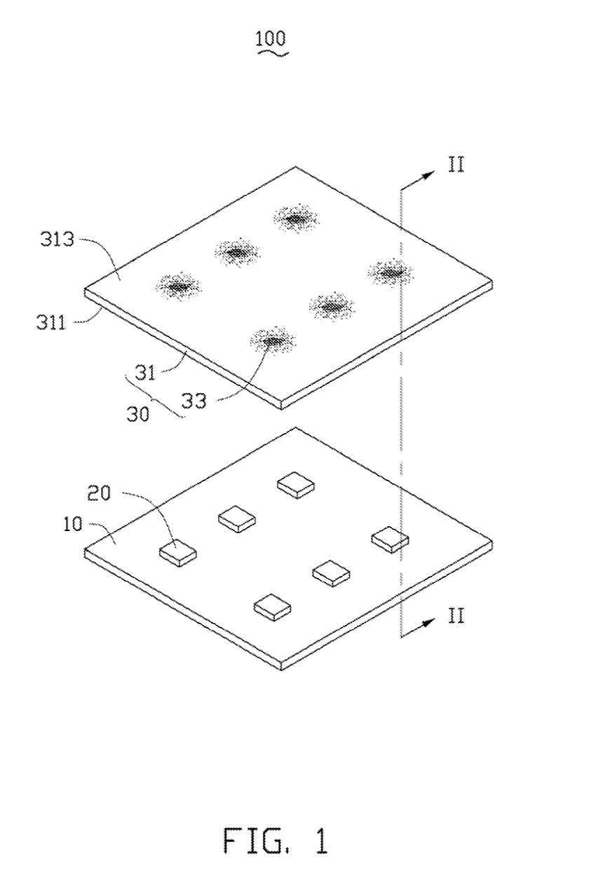

Referring to FIG. 1, a backlight module 100 in accordance with a first embodiment is provided. The backlight module 100 can be used for illuminating a liquid crystal display (LCD, not shown).

The backlight module 100 includes a substrate 10, a plurality of lighting chips 20 mounted on the substrate 10, and a light diffusion board 30 located above the lighting chips 20. Light emitted from the lighting chips 20 travels through the light diffusion board 30, and is diffused by the light diffusion board 30 to uniformly emit out. In this embodiment, each lighting chip 20 is a light emitting diode (LED), and the light diffusion board 30 is spaced from the lighting chips 20.

The substrate 10 is a flat plate with a flat top surface to support the lighting chips 20 thereon. The substrate 10 is made of material with good thermal conductivity, such as ceramic. The lighting chips 20 are spaced from each other, and electrically connect with a circuit (not shown) arranged on the top surface of the substrate 10.

The light diffusion board 30 is a flat plate. The light diffusion board 30 includes a main body 31 and a plurality of diffusion-enhancing portions 33 in the main body 31. Light emitted from the lighting chips 20 can be diffused by the main body 31 and the diffusion-enhancing portions 33. In this embodiment, the diffusion-enhancing portions 33 have higher light diffusibility than that of other portions of the main body 31 located between the diffusion-enhancing portions 33.

The main body 31 is made of transparent material, such as PMMA (polymethylmethacrylate). The main body 31 includes a flat bottom surface 311 and a flat top surface 313 opposite to the bottom surface 311. In this embodiment, the flat bottom surface 311 functions as a light incident surface of the light diffusion board 30, and the flat top surface 313 functions as a light output surface of the light diffusion board 30.

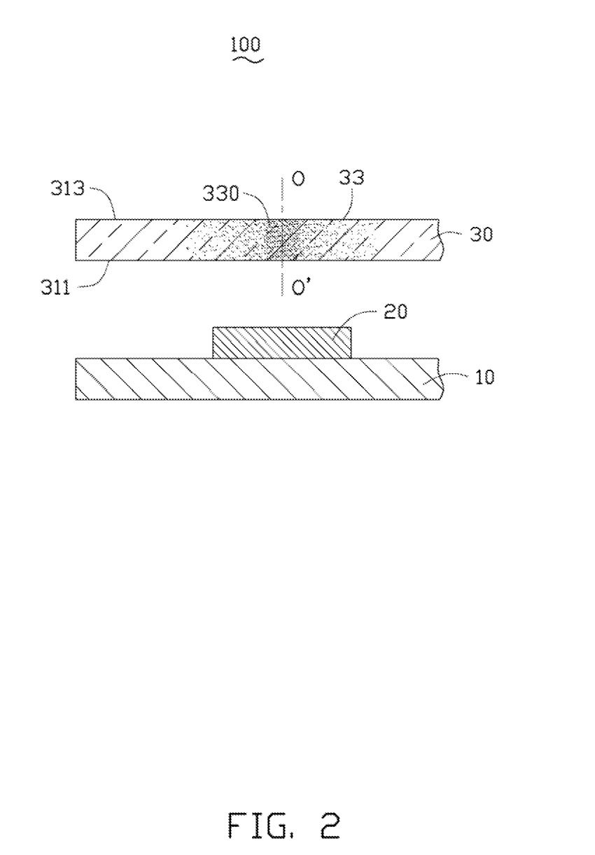

Also referring to FIG. 2, the diffusion-enhancing portions 33 are aligned with the lighting chips 20 respectively. A projection of each diffusion-enhancing portion 33 on the top surface of the substrate 10 covers a corresponding lighting chip 20.

The diffusion-enhancing portion 33 is formed by mixing diffusion particles 330 in the main body 31 when manufacturing the light diffusion board 30.

The density of the diffusion particles 330 is gradually decreased along a direction from the central axis O-O′ of the diffusion-enhancing portion 33 away from the central axis O-O′ to a periphery of the diffusion-enhancing portion 33, and the density is constant at any point along a thickness direction of each of the diffusion-enhancing portions 33.

In this embodiment, the density of the diffusion particles 330 is gradually decreased from the central axis O-O′ to a periphery of the diffusion-enhancing portion 33. Therefore, the diffusibility of the diffusion-enhancing portion 33 is gradually decreased from a central portion of the diffusion-enhancing portion 33 towards a peripheral portion thereof, and the diffusibility of the diffusion-enhancing portion 33 is constant at any point along the thickness direction of the diffusion-enhancing portion 33. The diffusion particles 330 contain polyacrylic acid micro-particles, or styrene micro-particles, or calcium carbonate micro-particles, or a composition of the polyacrylic acid micro-particles, styrene micro-particles and calcium carbonate micro-particles.

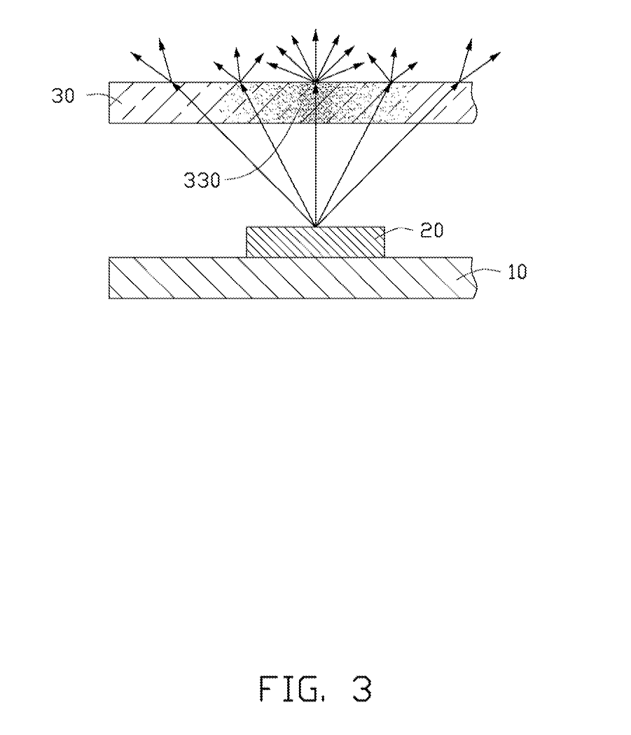

Referring to FIG. 3, according to the backlight module 100, because the lighting chips 20 are aligned with the diffusion-enhancing portions 33 respectively, most part of light near the center of the lighting chip 20 emits towards the diffusion-enhancing portion 33, and another part of light at peripheral sides of the lighting chip 20 emits towards the portions of the main body 31 located between the diffusion-enhancing portions 33. Because the diffusion-enhancing portions 33 have higher diffusibility than that of other portions of the main body 31 located between the diffusion-enhancing portions 33, light with higher intensity at the center of the lighting chip 20 is more divergently diffused than the light with lower intensity at peripheral sides of the lighting chip 20, whereby light emitted from the lighting chips 20 can be uniformly emitted out from the light diffusion board 30.

Furthermore, in the most part of light emitting into the diffusion-enhancing portions 33, a part of the light with higher light intensity emits into a central portion of the diffusion-enhancing portion 33, another part of light with lower light intensity emits into peripheral portion of the diffusion-enhancing portion 33. Because the diffusibility of the diffusion-enhancing portion 33 is gradually decreased from a central portion of the diffusion-enhancing portion 33 to the peripheral portion thereof, the part of light with higher light intensity is diffused more divergently than the part of light with lower light intensity, whereby the light emitted into the diffusion-enhancing 33 become more uniformly distributed, which improves the performance of the backlight module 100.

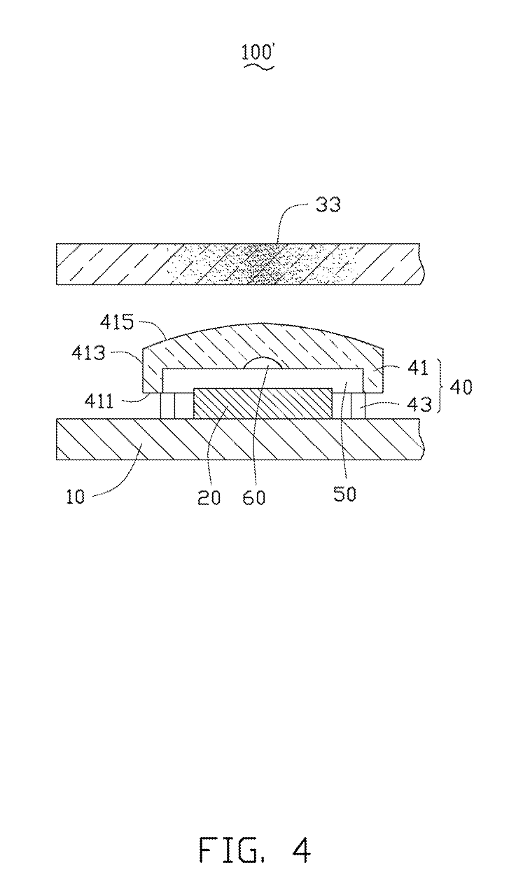

Referring to FIG. 4, another backlight module 100′ is provided in accordance with a second embodiment of the present disclosure. Compared with the backlight module 100 in the first embodiment, the backlight module 100′ further includes a plurality of lenses 40 located on the top surface of the substrate 10 and covering the lighting chips 20 correspondingly.

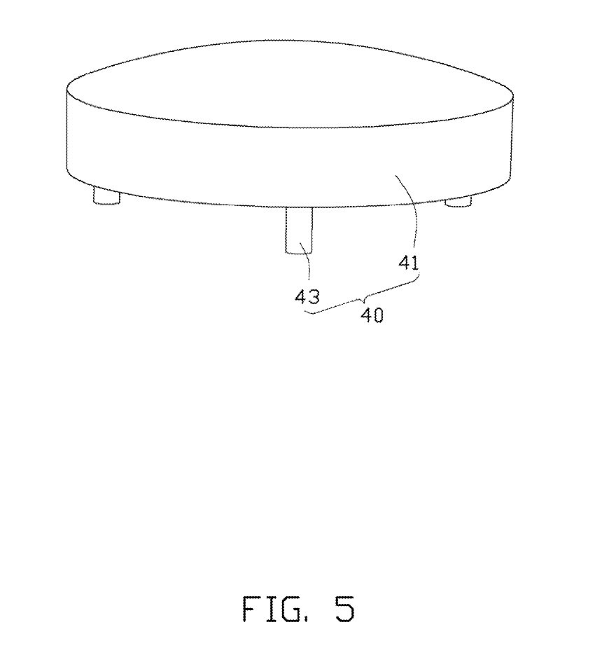

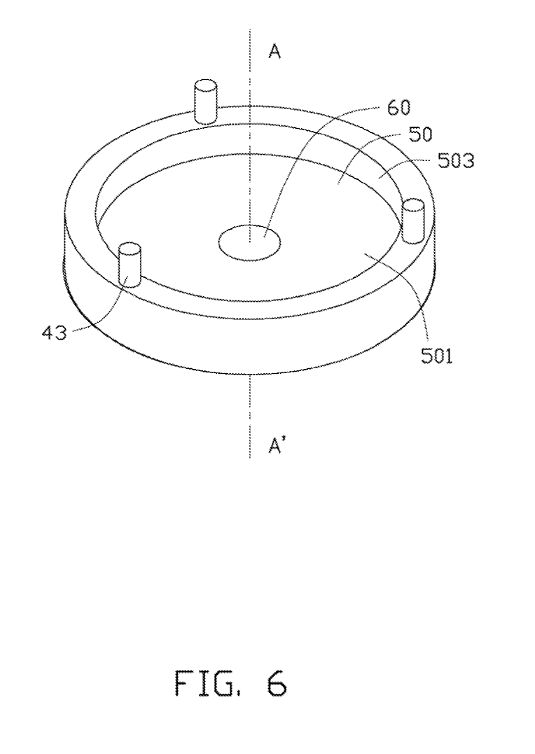

Referring to FIGS. 5-6, the lens 40 includes a light guiding portion 41 and a plurality of retaining portions 43 supporting the light guiding portion 41 on the substrate 10. The lens 40 is made of transparent material with a good optical performance, such as PMMA (polymethyl methacrylate), PC (Polycarbonate) plastic. The lens 40 is symmetrical with respect to a central axis A-A′ line (as shown in FIG. 6) of the lens 40.

The light guiding portion 41 is columnar. The light guiding portion 41 includes a bottom surface 411, a top surface 415 and an annular side surface 413 interconnecting the bottom surface 411 and the top surface 415 respectively. In this embodiment, the top surface 415 functions as a light output surface of the lens 40.

The bottom surface 411 is a flat, circular surface. A cavity 50 is vertically recessed from a central portion of the bottom surface 411 along a direction toward the top surface 415 of the lens 40. The cavity 50 is defined by a circular top surface 501 and an annular side surface 503. The cavity 50 is coaxial with the lens 40. In this embodiment, the cavity 50 is coaxial with the lighting chip 20.

A recess 60 is defined in a central portion of the top surface 501, and the recess 60 is coaxial with the lens 40. The recess 60 is aligned with a central portion of the lighting chip 20. An inner surface of the recess 60 is arc-shaped. The inner surface of the recess 60 is recessed from the central portion of the top surface of the cavity 50 along a direction toward the top surface 415 of the lens 40. In this embodiment, the top surface 501 of the cavity 50 and the inner surface of the recess 60 function as the light incident surface of the lens 40.

The annular side surface 413 extends upwardly from the periphery of the bottom surface 411, and the top surface 415 is convex upwardly from the top end of the annular side surface 413.

The retaining portion 43 extends downwardly from the bottom surface 411 of the lens 40 to fix the light guiding portion 41 on the top surface of the substrate 10. The retaining portion 43 is located on the outer edge of the bottom surface 411. Each retaining portion 43 is cylindrical. In this embodiment, the number of the retaining portions 43 is three, and the three retaining portions 43 are located at vertices of an equiperipheral triangle.

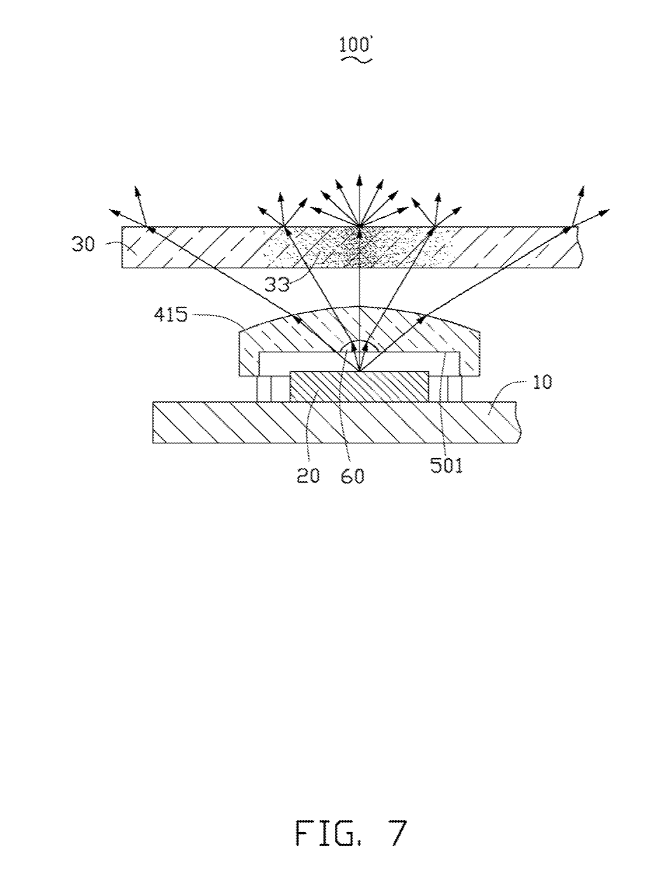

Also referring to FIG. 7, according to the backlight module 100′, a part of light near the center of the lighting chip 20 travels through the lens 40 from the inner surface of the recess 60, and this part of the light is refracted by the top surface 415 of the lens 40 to divergently emit towards the diffusion-enhancing portion 33 of the light diffusion board 30. Another part of light at the peripheral sides of the lighting chip 20 travels through the lens 40 from the top surface 501 of the cavity 50, and this part of light is refracted by the top surface 415 of the lens 40 to divergently emit towards the portions of the light diffusion board 30 between the diffusion-enhancing portions 33. In brief, before emitting into the light diffusion board 30 to be diffused thereby, the light emitted from the lighting chip 20 is firstly divergently refracted by the lens 40, whereby the light become further more uniformly distributed when it is emitted from the light diffusion board 30, which further improves the performance of the backlight module 100′.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A backlight module comprising:
a substrate;
a lighting chip mounted on a top surface of the substrate; and
a light diffusion board located above the lighting chip, the light diffusion board comprising a main body and a diffusion-enhancing portion arranged in the main body, the diffusion-enhancing portion having higher light diffusibility than that of other portion of the main body, the lighting chip being aligned with the diffusion-enhancing portion.

2. The backlight module of claim 1, wherein the light diffusibility of the diffusion-enhancing portion is gradually decreased along a direction from a central axis thereof towards a part of the diffusion-enhancing portion away from of the central axis.

3. The backlight module of claim 2, wherein the light diffusibility of the diffusion-enhancing portion is constant at any point along a thickness direction of the diffusion-enhancing portion.

4. The backlight module of claim 2, wherein the light diffusibility of the diffusion-enhancing portion is gradually decreased along a direction from the central axis thereof towards a periphery of the diffusion-enhancing portion away from the central axis.

5. The backlight module of claim 2, wherein the diffusion-enhancing portion comprises a plurality of diffusion particles mixed in the main body of the light diffusion board, and a density of the diffusion particles is gradually decreased from the central axis of the diffusion-enhancing portion towards a periphery of the diffusion-enhancing portion.

6. The backlight module of claim 5, wherein the density of the diffusion particles is constant at any point along a thickness of the diffusion-enhancing portion.

7. The backlight module of claim 6, wherein the diffusion particles comprise polyacrylic acid micro-particles.

8. The backlight module of claim 6, wherein the diffusion particles comprise styrene micro-particles.

9. The backlight module of claim 6, wherein the diffusion particles comprise carbonate micro-particles.

10. The backlight module of claim 6, wherein the diffusion particles comprise a composition of polyacrylic acid micro-particles, styrene micro-particles and styrene micro-particles.

11. The backlight module of claim 1, wherein a projection of the diffusion-enhancing portion on the top surface of the substrate covers the lighting chip.

12. The backlight module of claim 1, wherein the lighting chip is a light emitting diode.

13. The backlight module of claim 1, wherein a lens is located on the substrate and the lens covers the lighting chip.

14. The backlight module of claim 13, wherein the lens is aligned with the lighting chip, and light emitted from the lighting chip travels through the lens, and is refracted by the lens towards the light diffusion board.

15. The backlight module of claim 14, wherein the lens comprises a light guiding portion and a plurality of retaining portions extending downwardly from a bottom surface of the light guiding portion, and the retaining portions fix the lens on the substrate.

16. The backlight module of claim 15, wherein the number of the retaining portions is three, and the three retaining portions are located at three vertices of an equiperipheral triangle.

17. The backlight module of claim 13, wherein the lens defines a recess in a bottom face thereof, the recess facing and being aligned with a central portion of the lighting chip and a convex top surface facing toward the light diffusion board.

18. A backlight module comprising:
a substrate;
a plurality of lighting chips mounted on the substrate; and
a light diffusion board located above the lighting chips, the light diffusion board comprising a main body and a plurality of diffusion-enhancing portions arranged in the main body, the diffusion-enhancing portions being spaced from each other, the diffusion-enhancing portions having higher light diffusibility than that of other portions of the main body between the diffusion-enhancing portions, the diffusion-enhancing portions being aligned with the lighting chips respectively.

19. The backlight module of claim 18, wherein the light diffusibility of each of the diffusion-enhancing portions is gradually decreased from a central axis thereof towards a periphery of each of the diffusion-enhancing portions.

20. The backlight module claim 19, wherein each diffusion-enhancing portion comprises a plurality of light diffusion particles in the light diffusion board.
